(19) United States
(12) Patent Application Publication
(10) Pub. No.: US 2026/0141697 A1
(43) Pub. Date: May 21, 2026

(54) SYSTEMS AND METHODS FOR TRAINING MULTIMODAL LANGUAGE MODELS

(71) Applicant: Salesforce, Inc., San Francisco, CA (US)

(72) Inventors: Jieyu Zhang, Palo Alto, CA (US); Le Xue, Mountain View, CA (US); Jun Wang, Palo Alto, CA (US); Manli Shu, Greenbelt, MD (US); An Yan, Palo Alto, CA (US); Zeyuan Chen, Mountain View, CA (US); Ran Xu, Mountain View, CA (US)

(21) Appl. No.: 19/287,384

(22) Filed: Jul. 31, 2025

Related U.S. Application Data
(60) Provisional application No. 63/720,906, filed on Nov. 15, 2024.

(51) Int. Cl. G06V 10/774; G06V 10/25; G06V 10/26; G06V 10/82; G06V 10/94

(52) U.S. Cl. CPC G06V 10/7747; G06V 10/25; G06V 10/26; G06V 10/82; G06V 10/945

(57) ABSTRACT

A training framework includes a transparent and unbiased dataset generation pipeline to generate unbiased multi-modal training data for training a multi-modal LLM. Specifically, one or more images may be annotated using image recognition models, e.g., for object detection, attributes, relations, segmentation, etc. Then, the generated annotations are used to generate scene graph. A scene graph is a data structure that represents objects with attributes in an image as nodes and relationships between objects in an image as edges. Several computer programs are then used to systematically generate question-answer pairs. Because the computer programs include a set of known rules, how the data is generated is known explicitly and thus transparent. The question-answer pairs may be of several types, e.g., a type associated with each of the types of image recognition models. The question-answer pairs may be included in a training dataset and used to train a multimodal LLM.

### CROSS REFERENCE(S)

The instant application is a nonprovisional of and claim priority under 35 U.S.C. 119 to U.S. provisional application No. 63/720,906, filed Nov. 15, 2024, which is hereby expressly incorporated by reference herein in its entirety.

### TECHNICAL FIELD

The embodiments relate generally to machine learning systems for multimodal processing, and more specifically to training multimodal language models.

### BACKGROUND

AI agents, commonly known as AI agents or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI agents can assist with product recommendations, order tracking, and personalized shopping experiences. In information technology (IT) support, these agents can guide users through troubleshooting steps, helping them resolve software and hardware issues. Specifically, for network hazards, AI agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task.

An AI agent powered by a multimodal large language model (LLM) can integrate and analyze diverse data types—such as text, images, and structured inputs—to perform a wide range of tasks across domains. For example, in healthcare, it can interpret medical images like X-rays or MRIs alongside clinical notes to assist in diagnosis or treatment planning. In customer service, it can analyze both visual product issues and customer queries to provide accurate support. In scientific research, it can read charts, extract data from images, and interpret research papers simultaneously. This multimodal capability enables the AI agent to perform context-aware reasoning and decision-making in complex, information-rich environments.

However, training such multimodal LLMs to perform various tasks across language and vision often presents several technical challenges. First, construction of suitable training datasets requires aligned pairs or tuples across different modalities such as text and image, audio and image, or video and audio. Generating such datasets often depends on existing LLMs or other multimodal LLMs to synthesize cross-modal data. However, this approach introduces problems including hallucinated content, limited output controllability, lack of interpretability, and high computational cost when scaling data generation.

### BRIEF DESCRIPTION OF THE DRAWINGS

FIG. 1A shows an example operation of a multimodal LLM based AI agent, according to embodiments of the present disclosure.

FIG. 1B is a simplified diagram illustrating an example structure of multimodal large language model (MLLM) shown in FIG. 1A, according to embodiments described herein.

FIG. 2 is a simplified diagram illustrating a multimodal data generation pipeline for generating training data for the MLLM shown in FIGS. 1A-1B, according to embodiments described herein.

FIGS. 3A-3D provide example generated vision-language instruction data shown in FIG. 2, according to embodiments described herein.

FIG. 4 provides an example diagram illustrating aspects of the data annotation pipeline generating a scene graph shown in FIG. 2, according to embodiments described herein.

FIG. 5 is a simplified diagram illustrating a computing device implementing the multi-modal training framework described in FIGS. 1-4, according to one embodiment described herein.

FIG. 6 is a simplified diagram illustrating the neural network structure implementing the multi-modal training module described in FIG. 5, according to some embodiments.

FIG. 7 is a simplified block diagram of a networked system suitable for implementing the multi-modal training framework described in FIGS. 1-6 and other embodiments described herein.

FIG. 8 is an example logic flow diagram illustrating a method of user-directed multimodal data generation for training a neural network-based multimodal language model based on the framework shown in FIGS. 1A-7, according to some embodiments described herein.

FIGS. 9-10 provide example data plot charts illustrating

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

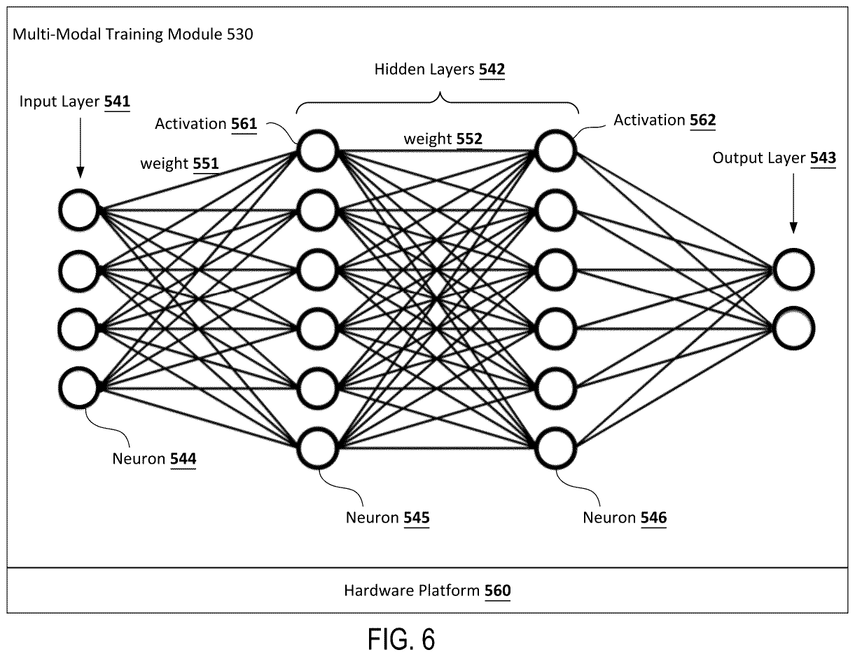

As used herein, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture may comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG. 6.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pr-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

As used herein, the term “AI agent” may refer to a set of software and/or hardware that processes information from its environment and takes action to achieve specific goals such as executing a task. For example, an AI agent (like a chatbot or virtual assistant) might use an LLM as a component but also integrate tools like web browsing, APIs, databases, and other forms of reasoning to complete tasks.

### Overview

While multi-modal LLMs have been widely used in different applications, high-performing multi-modal LLMs (such as GPT-40) may be used to generate multi-modal training data for fine-tuning smaller models. Existing data generation pipelines e.g., using a prompt for a multi-modal LLM to generate desired multi-modal data, are not transparent and often produce biased datasets. For example, a multimodal LLM may successfully detect objects in images in response to a query but not understand the relationship between the objects. In this example, a dataset created by the multimodal LLM would be biased towards object detection and against object relationships. Thus, a model training on the biased dataset would have bias for object detection over object relationships. Furthermore, there is no systematic way of controlling the types of entities and relationships in datasets generated with multimodal LLMs.

Embodiments described herein provide a training framework including a transparent and unbiased dataset generation pipeline to generate unbiased multi-modal training data for training a multi-modal LLM. Specifically, one or more images may be annotated using image recognition models, e.g., for object detection, attributes, relations, segmentation, etc. Then, the generated annotations are used to generate scene graph. A scene graph is a data structure that represents objects with attributes in an image as nodes and relationships between objects in an image as edges. Several computer programs are then used to systematically generate question-answer pairs. Because the computer programs include a set of known rules, how the data is generated is known explicitly and thus transparent. The question-answer pairs may be of several types, e.g., a type associated with each of the types of image recognition models. The question-answer pairs may be included in a training dataset and used to train a multimodal LLM.

In this way, the transparent data generation pipeline improves the training process of multimodal MLLMs by providing high-quality, diverse, and controllable training data. By leveraging rule-based programs and structured annotations such as scene graphs, the pipeline ensures that training samples are accurate, explainable, and systematically varied across multiple vision-language tasks. This reduces noise and biases commonly found in datasets generated by generative models and allows for better alignment between visual inputs and language outputs. As a result, multimodal LLMs trained on this data achieve more consistent and reliable performance, particularly in tasks requiring fine-grained visual reasoning and grounded language understanding.

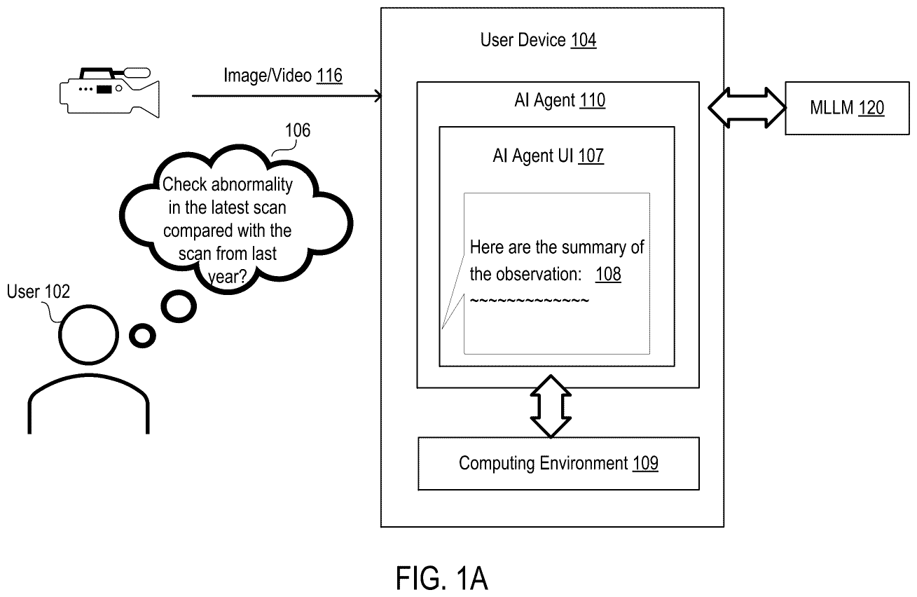

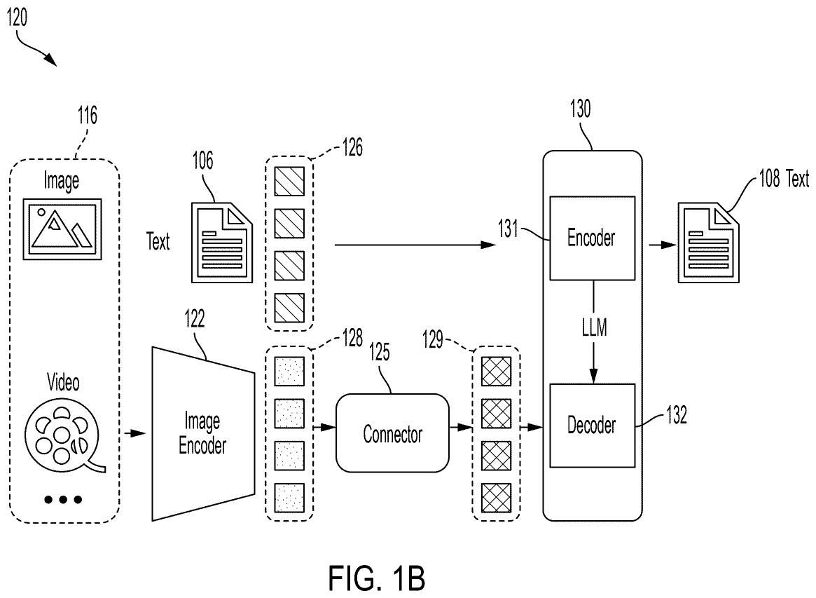

FIG. 1A shows an example operation of a multimodal LLM based AI agent, according to embodiments of the present disclosure. A multimodal LLM-based AI agent 110 may be implemented on a user device 104 to receive a user task request 106 as a natural language input and one or more multimodal input such as images or videos 116, typically through a chat or command interface 107. This request 106 may range from simple queries to more complex tasks like data analysis, automation, or even generating content. The AI agent 110 may be built upon a multimodal LLM 120.

An example would be using the MLLM-based AI agent in healthcare involves analyzing mammography scans for early cancer detection. The AI agent 110 may receive multiple mammogram images from the same patient taken in different years, and a user request 106 to analyze the medical images. Using its multimodal capabilities, the MLLM 120 processes the multiple images 116 and detects anatomical structures, breast tissue density, and potential abnormalities such as masses or calcifications. Additionally, the user text input 106 may further incorporate clinical text reports, patient history, and known risk factors, the AI agent 110 may contextualize its findings and generate a detailed summary highlighting any significant changes. This summary can include visual annotations and language explanations, helping radiologists prioritize cases for further review.

In one embodiment, the MLLM 120 may be hosted at an external server, a cloud service, and/or the like that is accessible by a communication network. In a different implementation, the MLLM 120 may be hosted on the user device 104. An input to the MLLM 120 may comprise a text input 106 and instruction provided to the MLLM 120 to guide its behavior or responses in a particular way, referred to as a “system prompt.” For example, the system prompt may contain instruction for the MLLM 120 to analyze the input images 116 and respond according to the request identified in the text input 106, and generate an output in a certain format, e.g., suggested code program, text description, etc. The MLLM 120 may in turn generate a response 108 based on an input combining the task request 106 and input images 116. Additional details on the MLLM 120 generating output tokens to form the response 108 may be described in FIG. 1B.

The response 108 may include instructions, explanations, code scripts or direct actions to address the task request 106. Such response 108 may be displayed via the AI agent interface 107 for transparency. For example, in addition to the response 108 that describes a summary of possible early cancer detection findings based on the input medical image scans 116, the MLLM 120 may generate computer-executable commands (e.g., system-level commands, Python scripts, etc.) that can directly trigger actions and/or interactions with the computing environment 109 on the user device 104.

For example, the computing environment 109 may comprise an image display and/or editing application. The MLLM 120 may generate a code script—e.g., in Python using libraries such as OpenCV or matplotlib—that overlays bounding boxes or heatmaps on specific regions of the input images 116 corresponding to the text response 108.

In this way, the MLLM-based AI agent 110 may facilitate end-to-end workflow to automate the task request 106.

FIG. 1B is a simplified diagram illustrating an example structure of MLLM 120 shown in FIG. 1A, according to embodiments described herein. The MLLM architecture 120 may comprise an image encoder 122, a connector module 125, and an LLM 130. In some implementations, the LLM 130 may comprise an encoder 131 and a decoder 132. In another example, the LLM 130 may be a decoder-only language model, and a separate text encoder 131 may be employed.

To process a text query 106 along with multiple input images 116 to generate an informed answer, each image is first processed independently by the image encoder 122, which extracts high-dimensional visual features representing objects, textures, spatial relationships, and other relevant content. These encoded visual embeddings 128 are then passed to the connector 125, which transforms and aligns the visual embeddings 128 into embeddings 129 having a format compatible with the LLM's input space. The connector 125 may provide that visual information is structured in a way that preserves semantic meaning and positional context across the different images.

Simultaneously, the LLM 130 may receives the text query 106 (and any additional text contextual information and/or prompt) and encode the text input into text embeddings by the text encoder 313. Along with the visual embeddings 129 provided by the connector 125, the LLM decoder 132 may perform multimodal reasoning to interpret the query 106 in the context of the image content. The LLM 130 can then synthesize information across the multiple images 116—comparing visual features, identifying patterns or changes, and integrating temporal or relational cues—to generate a coherent, contextually grounded text response 108. This architecture may thus enable applications such as answering diagnostic questions using a series of medical scans, analyzing satellite images over time, or comparing product images for defect detection, and/or the like.

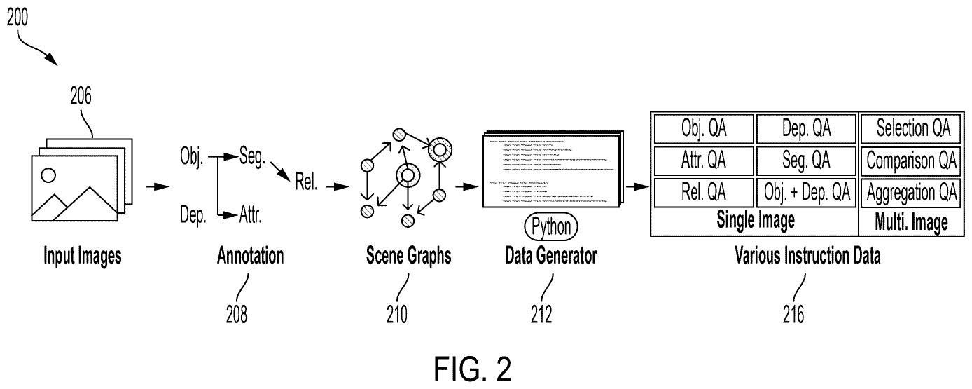

FIG. 2 is a simplified diagram illustrating a multimodal data generation pipeline 200 for generating training data for the MLLM 120 shown in FIGS. 1A-1B, according to embodiments described herein. The data pipeline 200 may be a deterministic, programmatic pipeline built on scene graphs and predefined rule-based scripts.

In one embodiment, input images 206 from image datasets, such as Visual Genome and DataComp, may be annotated with scene graphs 210. For example, a scene graph 210 is a structured representation of an image that captures its semantic content by identifying objects, their attributes, and the relationships between them. In the scene graph 210, objects such as “person,” “bench,” or “dog” are represented as nodes, and relationships like “sitting on” or “next to” are represented as edges connecting these nodes. Attributes such as “brown” or “wooden” are also attached to objects to provide additional detail. This graph-based format may allow machine-readable understanding of visual scenes, supporting tasks such as visual question answering, image captioning, and controllable data generation for training multimodal models 120.

In one embodiment, the annotation pipeline 208 may comprise a user interface for a human annotator to identify image segments, objects, attributes, relationships between objects, and/or the like via the user interface. In another implementation, a scene graph generation pipeline 208 built on a vision-language model may perform object detection, relationship extraction, image segmentation, and depth estimation to produce scene graphs 210 automatically.

These generated scene graphs 210 are then fed to the programmatically based instruction generator 212 (e.g., Python script) to create consistent and structured instructional data 216. For example, the Python script generator may generate question and answer pairs based on a scene graph for a single image, inquiring about the objects, attributes, relationship between objects, segments and/or the like in the single image. For another example, the Python script generator may generate question and answer pairs based on multiple images, such as selecting an image from multiple images according to an input query, comparing multiple images, aggregating visual content from multiple images to answer a question, and/or the like.

For example, the scene graph 210 may be an augmented scene graph, including depth and segmentation labels. Given an input image x (e.g., 206) with size (w, h), which have N objects {i₁, . . . , i_{N}} and each object iⱼ has a list of attribute

$${a}_{a t t r}^{j k} .$$

The augmented scene graph 210 is G=(V,E), where

$$V ⊂ {-}_{jk} \{ {i}_{1} , \cdot \cdot \cdot , {i}_{N} \} , E = \{ [ {i}_{j} , {i}_{k} , {a}_{rel}^{jk} . ) \vert {i}_{j} , {i}_{k} ∈ V \} and {a}_{rel}^{jk}$$

is the relation between objects iⱼ and iₖ. Each object iⱼ has its corresponding bounding box and label pair a_det\hat{ }j, segmentation

$${a}_{seg}^{j} ,$$

and a list or attribute

$${a}_{attr}^{j} .$$

Additionally, depth annotation

$${a}_{dep}^{j}$$

may be added as an augmented feature.

In one embodiment, a plurality of data generators 212 may generate ingle-image visual instruction data by transforming an augmented scene graph 210 into a plurality of high-level perceptual question-answer pairs for each image. Each generator utilizes multiple pre-defined templates, which systematically integrate these annotations from the scene graph 212 to produce diverse instruction data. These generators are crafted to cover the model's ability to compare, retrieve, and reason about basic visual concepts of objects, attributes, and relations based on the detailed information encoded in each scene graph 212.

In another embodiment, a plurality of data generators 212 may generate multi-image visual instruction data. While single-image generators focus on producing instruction data from individual scene graphs, multi-image generators may take multiple scene graphs as input to generate question-answer pairs that span across images. These multi-image generators enable more complex queries, such as selection (e.g., “Which image contains more red objects?”), comparison (e.g., “What are the objects common in these images?”), and aggregation (e.g., “How many red objects in total in these images?”) questions.

Therefore, because the data generator 212 may be programmable and adjustable to reflect human preference in instructional data. Given an accurate scene graph 212, the use of data generator 212 provides a transparent and interpretable data generation process with consistent and controllable output behavior. The generated instruction data 216 are directly derived from structured scene graph data 210, avoiding probabilistic errors and hallucinations commonly found in LLM-generated outputs.

In one embodiment, the data generator 212 is programmable and thus may be readily expanded to accommodate a large number of input images for parallel generation of instruction data from multiple images. Additionally, the data generator 212 may be modified to incorporate new types of visual reasoning tasks, and adapt the system to meet evolving needs. This data generation architecture 200 decouples data creation from reliance on large-scale generative models, reducing computational cost and improving scalability.

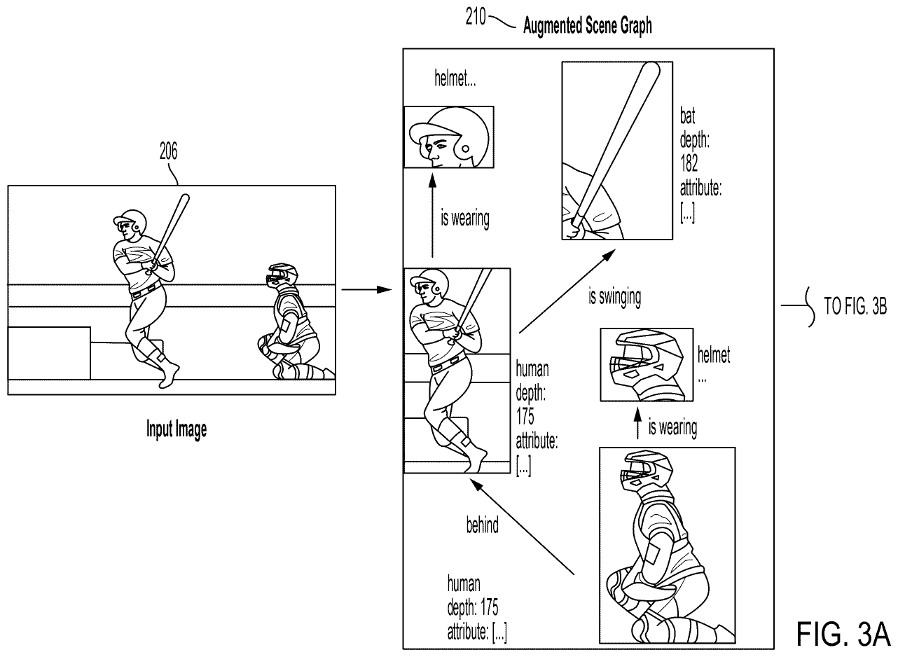

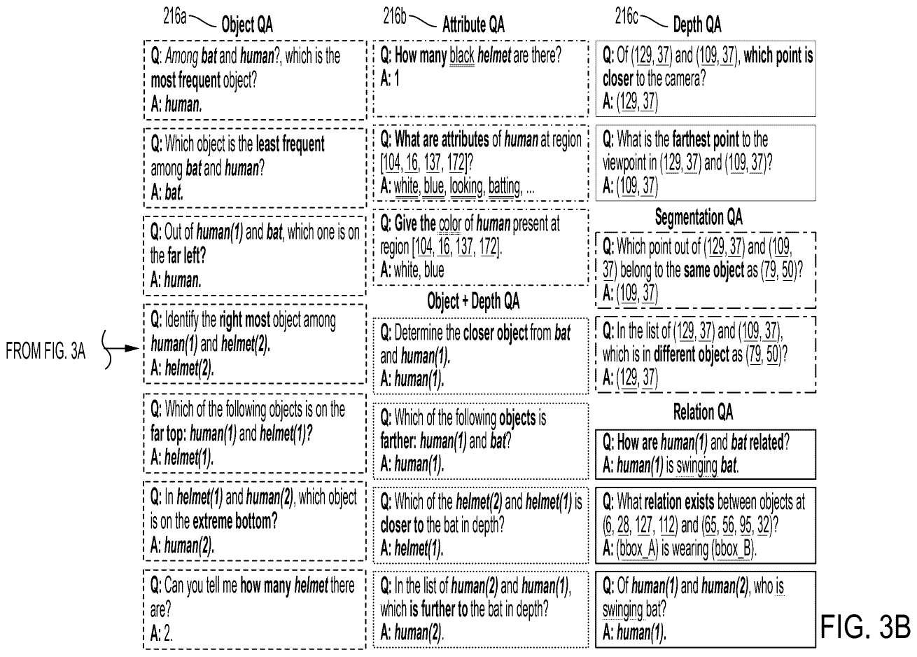

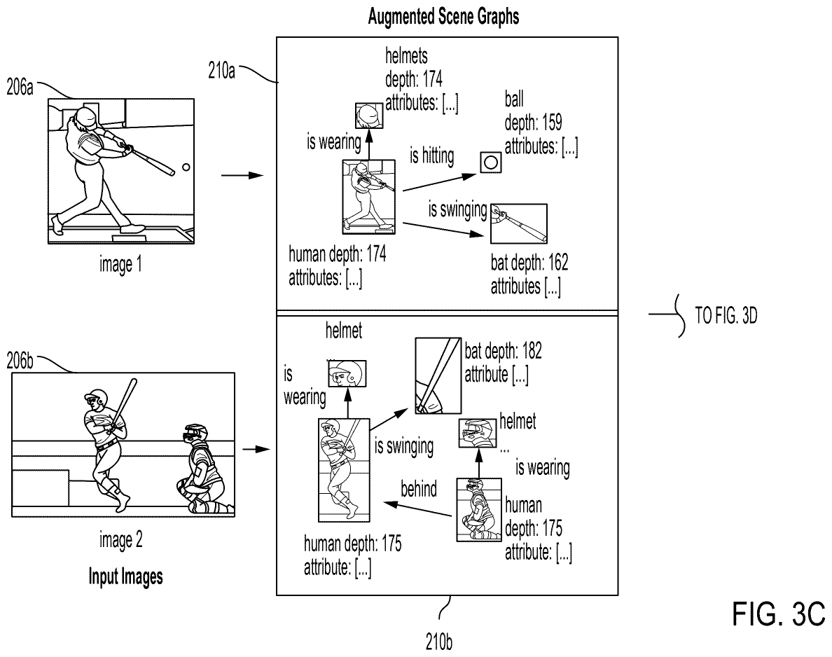

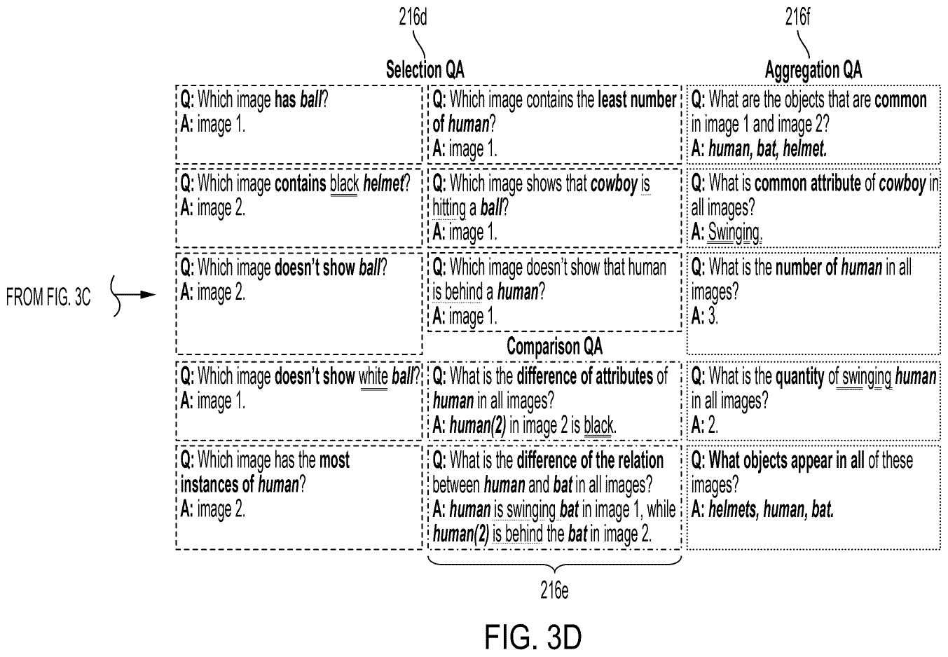

FIGS. 3A-3D provide example generated vision-language instruction data 216 shown in FIG. 2, according to embodiments described herein. As shown in FIG. 3A and FIG. 3B, given an example input image 206 depicting a baseball scene, the augmented scene graph 210 may be generated comprising nodes representing an object of a baseball player, and the object is segmented into segments such as “helmet,” “bat,” etc. Additional parameters such as depth, attributes are reflected into the augmented scene graph 210. Based on the augmented graph 210, question-answer pairs relating to the object 216a, question-answer pairs relating to the attributes 216b, question-answer pairs relating to the depth 216c, and/or various other question-answer pairs relating to the segmentation or relations may be generated.

As shown in FIG. 3C and FIG. 3D, two input images depicting baseball scenes 206a-206b may each be encoded into augmented scene graphs 210a-210b, respectively. Complex queries, such as selection questions 216d (e.g., “Which image has bail?”), comparison 216e (e.g., “what is the difference of attributes of human in all the images?”), and aggregation 215f (e.g., “what are the objects that are common in both images?”) questions.

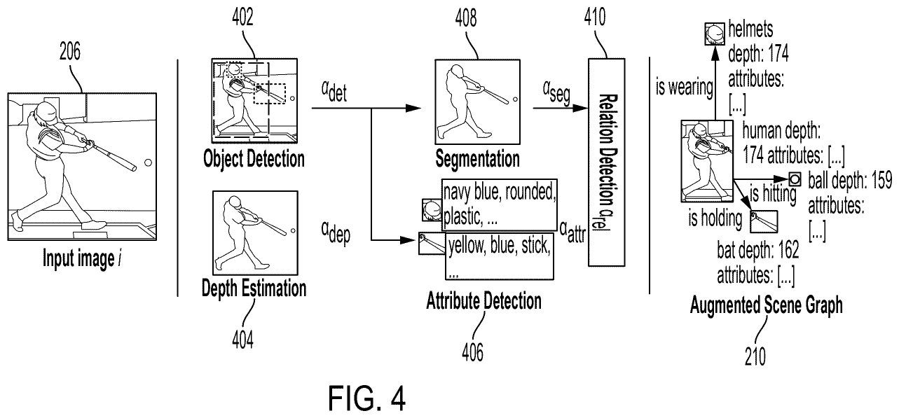

FIG. 4 provides an example diagram illustrating aspects of the data annotation pipeline 208 generating a scene graph 210 shown in FIG. 2, according to embodiments described herein. an image model may process the input image 206 to perform object detection, image segmentation, attribute generation, relation generation, and depth estimation. For example, an object detection model f_{det}(x) may generate and annotate all bounding boxes and the corresponding labels of all objects in the input image 206. For example, for object j, the object detection model 402 may output a_det\hat{ }j=([x_min\hat{ }j, y_min\hat{ }j, x_max\hat{ }j, y_max\hat{ }j], lⱼ), where (x_min\hat{ }j, y_min\hat{ }j) denotes the left bottom point of the bounding box and lᵢ denotes the label for object j.

In one implementation, a depth estimation model 404 may generate pixel-wise depth annotation a_{dep}. The pixel wise depth annotation can be used to infer the depth of objects for comparing depth among objects.

In one implementation, an image segmentation model 408 f_{seg}(x, a_{det}) may generate better object representations by taking the image x and bounding boxes a_{det} from object detection model 402 as input. Specifically, the segmentation model 408 may draw the pixel-wise segmentation a_{seg}∈ [symbol] according to a_{det}.

In one implementation, an attribute detection model 406 may be obtained by finetuning vision-language models. For example, the training data is constructed from a large-scale attribute dataset, using bounding box annotations to crop each object as a standalone image. Corresponding attribute annotations serve as target outputs. The prompt template “<image> {object_label}” may be used for the attribute detection model 406 for fine-tuning data generation.

In one implementation, a relation detection model 410 may retrieve the relations

$${a}_{rel}^{jk}$$

for all pairs of objects iⱼ and iₖ in image x (206) according to their segmentation. To achieve this, the relation detection model

$${f}_{rel} ( x , {a}_{seg}^{j} , {a}_{s e g}^{k} ) ,$$

may take the whole image 206 and segmentation of objects iⱼ and iₖ from the segmentation model 408 as input, and generate a relation

$${\tilde{a}}_{rel}^{jk} .$$

The generated relation may then be grounded by comparing the similarity between

$${\tilde{a}}_{rel}^{jk}$$

and the relation library and the top-1 result may be selected as the

$${a}_{rel}^{jk} .$$

Therefore, an augmented scene graph 210 may be built as a graph structure using the attributes, relationships from the various models 402, 404 406, 408 and 410.

### Computer and Network Environment

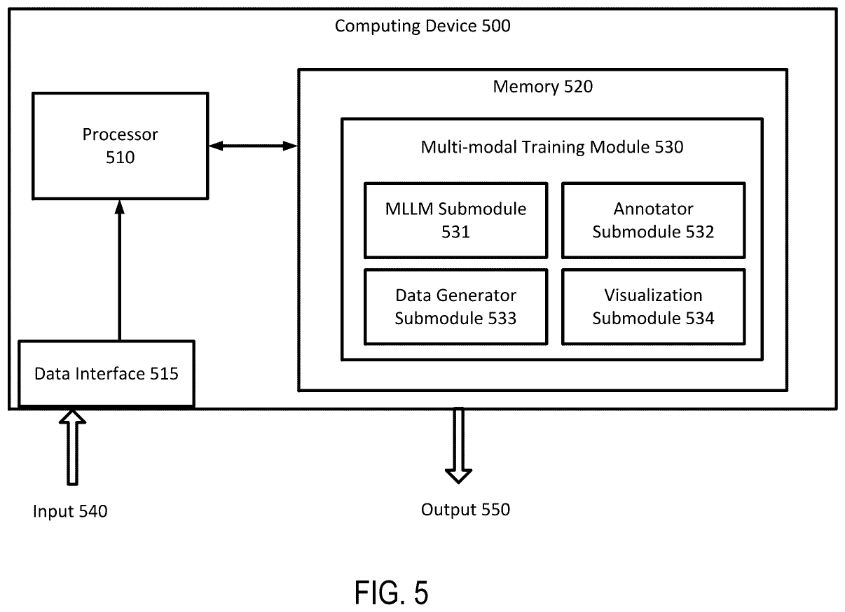

FIG. 5 is a simplified diagram illustrating a computing device implementing the multi-modal training framework described in FIGS. 1-4, according to one embodiment described herein. As shown in FIG. 5, computing device 500 includes a processor 510 coupled to memory 520. Operation of computing device 500 is controlled by processor 510. And although computing device 500 is shown with only one processor 510, it is understood that processor 510 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 500. Computing device 500 may be implemented as a stand-alone subsystem, as a board added to a computing device, and/or as a virtual machine.

Memory 520 may be used to store software executed by computing device 500 and/or one or more data structures used during operation of computing device 500. Memory 520 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 510 and/or memory 520 may be arranged in any suitable physical arrangement. In some embodiments, processor 510 and/or memory 520 may be implemented on a same board, in a same package (e.g., system-in-package), on a same chip (e.g., system-on-chip), and/or the like. In some embodiments, processor 510 and/or memory 520 may include distributed, virtualized, and/or containerized computing resources. Consistent with such embodiments, processor 510 and/or memory 520 may be located in one or more data centers and/or cloud computing facilities.

In another embodiment, processor 510 may comprise multiple microprocessors and/or memory 520 may comprise multiple registers and/or other memory elements such that processor 510 and/or memory 520 may be arranged in the form of a hardware-based neural network, as further described in FIG. 5B.

In some examples, memory 520 may include non-transitory, tangible, machine readable media that includes executable code that when run by one or more processors (e.g., processor 510) may cause the one or more processors to perform the methods described in further detail herein. For example, as shown, memory 520 includes instructions for multi-modal training module 530 that may be used to implement and/or emulate the systems and models, and/or to implement any of the methods described further herein. multi-modal training module 530 may receive input 540 such as an input training data (e.g., vision instruction data 216 in FIG. 2) via the data interface 515 and generate an output 550 which may be an answer to a question based on input images.

The data interface 515 may comprise a communication interface, a user interface (such as a voice input interface, a graphical user interface, and/or the like). For example, the computing device 500 may receive the input 540 (such as a training dataset) from a networked database via a communication interface. Or the computing device 500 may receive the input 540, such as images and/or a text question, from a user via the user interface.

In some embodiments, the multi-modal training module 530 is configured to train a multi-modal LLM. The multi-modal training module 530 may further include an MLLM submodule 531 (e.g., similar to 120 in FIGS. 1A-1B), annotator submodule 532 (e.g., similar to 208 in FIG. 2), data generator submodule 533 (e.g., similar to 212 in FIG. 2), and a visualization submodule 534. For example, the visualization submodule 534 may generate an output such as an overlaying bounding box on an input image in the input 540, such as to identify suspicious area in a medical image scan in response to a text question.

Some examples of computing devices, such as computing device 500 may include non-transitory, tangible, machine readable media that include executable code that when run by one or more processors (e.g., processor 510) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 6 is a simplified diagram illustrating the neural network structure implementing the multi-modal training module 530 described in FIG. 5, according to some embodiments. In some embodiments, the multi-modal training module 530 and/or one or more of its submodules 531-534 may be implemented at least partially via an artificial neural network structure shown in FIG. 5B. The neural network comprises a computing system that is built on a collection of connected units or nodes, referred to as neurons (e.g., 544, 545, 546). Neurons are often connected by edges, and an adjustable weight (e.g., 551, 552) is often associated with the edge. The neurons are often aggregated into layers such that different layers may perform different transformations on the respective input and output transformed input data onto the next layer.

For example, the neural network architecture may comprise an input layer 541, one or more hidden layers 542 and an output layer 543. Each layer may comprise a plurality of neurons, and neurons between layers are interconnected according to a specific topology of the neural network topology. The input layer 541 receives the input data (e.g., 540 in FIG. 5A), such as. The number of nodes (neurons) in the input layer 541 may be determined by the dimensionality of the input data (e.g., the length of a vector of an input question and/or an image vector). Each node in the input layer represents a feature or attribute of the input.

The hidden layers 542 are intermediate layers between the input and output layers of a neural network. It is noted that two hidden layers 542 are shown in FIG. 5B for illustrative purpose only, and any number of hidden layers may be utilized in a neural network structure. Hidden layers 542 may extract and transform the input data through a series of weighted computations and activation functions.

For example, as discussed in FIG. 5A, the multi-modal training module 530 receives an input 540 of image features and a text and transforms the input into an output 550 of an answer. To perform the transformation, each neuron receives input signals, performs a weighted sum of the inputs according to weights assigned to each connection (e.g., 551, 552), and then applies an activation function (e.g., 561, 562, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 541 is transformed into rather different values indicative data characteristics corresponding to a task that the neural network structure has been designed to perform.

The output layer 543 is the final layer of the neural network structure. It produces the network's output or prediction based on the computations performed in the preceding layers (e.g., 541, 542). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the multi-modal training module 530 and/or one or more of its submodules 531-534 may comprise the transformative neural network structure of layers of neurons, and weights and activation functions describing the non-linear transformation at each neuron. Such a neural network structure is often implemented on one or more hardware processors 510, such as a graphics processing unit (GPU). An example neural network may be a Transformer multimodal LLM, and/or the like.

In one embodiment, the multi-modal training module 530 and its submodules 531-534 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may processes the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q K, V matrices contain tunable weights of a Transformer-based language model that are updated during training. Then, the attention mechanism computes attention scores between all tokens in the input sequence using the Q, K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM (such as LLM 110a-d) may receive a natural language input (such as a question) and generate a natural language output (such as an answer to the question).

In one embodiment, the multi-modal training module 530 and its submodules 531-534 may be implemented by hardware, software and/or a combination thereof. For example, the multi-modal training module 530 and its submodules 531-534 may comprise a specific neural network structure implemented and run on various hardware platforms 560, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 560 used to implement the neural network structure is specifically configured based on factors such as the complexity of the neural network, the scale of the tasks (e.g., training time, input data scale, size of training dataset, etc.), and the desired performance.

For example, to deploy the multi-modal training module 530 and its submodules 531-534 and/or any other neural network models such as vision-language models onto hardware platform 560, the neural network based modules 530 and its submodules 531-534 may be optimized for deployment by converting it to a suitable format, such as ONNX or TensorRT, to improve performance and compatibility. Next, depending on the size and workload requirements for modules 530 and its submodules 531-534, hardware types may be chosen for deployment, e.g., processing capacity, GPU memory size, and/or the like. Frameworks and drivers for the chosen hardware 560 frameworks and drivers may thus be installed, such as PyTorch, TensorFlow, or CUDA, to support the hardware platform 560. Then, weights and parameters of the multi-modal training module 530 and its submodules 531-534 may be loaded to the hardware 560. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the multi-modal training module 530 and its submodules 531-534 may be deployed as a service, then they may be integrated with an API endpoint, using tools like Flask, FastAPI, or a cloud platform serverless services, and is accessible by a remote user via a network.

In another embodiment, some or all of layers 541, 542, 543 and/or neurons 542, 545, 546, and operations there between such as activations 561, 562, and/or the like, of the multi-modal training module 530 and its submodules 531-534 may be realized via one or more ASICs. For example, each neuron 542, 545 and 546 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the multi-modal training module 530 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based multi-modal training module 530 and one or more of its submodules 531-534 may be trained by iteratively updating the underlying parameters (e.g., weights 551, 552, etc., bias parameters and/or coefficients in the activation functions 561, 562 associated with neurons) of the neural network based on the loss. For example, during forward propagation, the training data such as vision instructional data (e.g., 216 in FIG. 2) are fed into the neural network. The data flows through the network's layers 541, 542, with each layer performing computations based on its weights, biases, and activation functions until the output layer 543 produces the network's output 550. In some embodiments, output layer 543 produces an intermediate output on which the network's output 550 is based.

The output generated by the output layer 543 is compared to the expected output (e.g., a “ground-truth” such as the corresponding answer) from the training data, to compute a loss function that measures the discrepancy between the predicted output and the expected output. For example, the loss function may be cross entropy, MMSE, and/or the like. Given the loss, the negative gradient of the loss function is computed with respect to each weight of each layer individually. Such negative gradient is computed one layer at a time, iteratively backward from the last layer 543 to the input layer 541 of the neural network. These gradients quantify the sensitivity of the network's output to changes in the parameters. The chain rule of calculus is applied to efficiently calculate these gradients by propagating the gradients backward from the output layer 543 to the input layer 541.

In one embodiment, the neural network based multi-modal training module 530 and one or more of its submodules 531-534 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

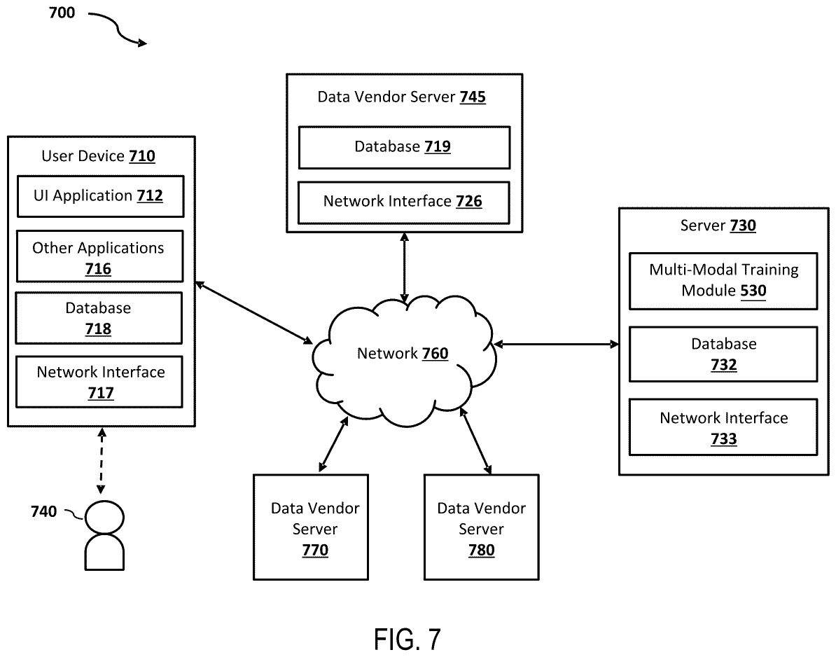

In some embodiments, multi-modal training module 530 and its submodules 531-534 may be housed at a centralized server (e.g., computing device 500) or one or more distributed servers. For example, one or more of multi-modal training module 530 and its submodules 531-534 may be housed at external server(s). The different modules may be communicatively coupled by building one or more connections through application programming interfaces (APIs) for each respective module. Additional network environment for the distributed servers hosting different modules and/or submodules may be discussed in FIG. 7.

During a backward pass, parameters of the neural network are updated backwardly from the last layer to the input layer (backpropagating) based on the computed negative gradient using an optimization algorithm to minimize the loss. The backpropagation from the last layer 543 to the input layer 541 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as processing unseen medical scans, traffic sign identification in real-time autonomous driving systems, and/or the like.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in computer vision and various downstream applications of computer vision, such as but not limited to medical imaging, autonomous driving, surveillance, and/or the like.

FIG. 7 is a simplified block diagram of a networked system 700 suitable for implementing the multi-modal training framework described in FIGS. 1-6 and other embodiments described herein. In one embodiment, system 700 includes the user device 710 which may be operated by user 740, data vendor servers 745, 770 and 780, server 730, and other forms of devices, servers, and/or software components that operate to perform various methodologies in accordance with the described embodiments. Exemplary devices and servers may include device, stand-alone, and enterprise-class servers which may be similar to the computing device 500 described in FIG. 5A, operating an OS such as a MICROSOFT® OS, a UNIX® OS, a LINUX® OS, or other suitable device and/or server-based OS. It can be appreciated that the devices and/or servers illustrated in FIG. 7 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 710, data vendor servers 745, 770 and 780, and the server 730 may communicate with each other over a network 760. User device 710 may be utilized by a user 740 (e.g., a driver, a system admin, etc.) to access the various features available for user device 710, which may include processes and/or applications associated with the server 730 to receive an output data anomaly report.

User device 710, data vendor server 745, and the server 730 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 700, and/or accessible over network 760.

User device 710 may be implemented as a communication device that may utilize appropriate hardware and software configured for wired and/or wireless communication with data vendor server 745 and/or the server 730. For example, in one embodiment, user device 710 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 710 of FIG. 7 contains a user interface (UI) application 712, and/or other applications 716, which may correspond to executable processes, procedures, and/or applications with associated hardware. For example, the user device 710 may receive a message indicating an answer based on input images from the server 730 and display the message via the UI application 712. In other embodiments, user device 710 may include additional or different modules having specialized hardware and/or software as required.

In one embodiment, UI application 712 may communicatively and interactively generate a UI for an AI agent implemented through the multi-modal training module 530 (e.g., an LLM agent) at server 730. In at least one embodiment, a user operating user device 710 may enter a user utterance, e.g., via text or audio input, such as a question, uploading a document, and/or the like via the UI application 712. Such user utterance may be sent to server 730, at which multi-modal training module 530 may generate a response via the process described in FIGS. 1-6. The multi-modal training module 530 may thus cause a display of an answer based on input images at UI application 712 and interactively update the display in real time with the user utterance.

In various embodiments, user device 710 includes other applications 716 as may be desired in particular embodiments to provide features to user device 710. For example, other applications 716 may include security applications for implementing client-side security features, programmatic client applications for interfacing with appropriate application programming interfaces (APIs) over network 760, or other types of applications. Other applications 716 may also include communication applications, such as email, texting, voice, social networking, and IM applications that allow a user to send and receive emails, calls, texts, and other notifications through network 760. For example, the other application 716 may be an email or instant messaging application that receives a prediction result message from the server 730. Other applications 716 may include device interfaces and other display modules that may receive input and/or output information. For example, other applications 716 may contain software programs for asset management, executable by a processor, including a graphical user interface (GUI) configured to provide an interface to the user 740 to view an answer based on input images.

User device 710 may further include database 718 stored in a transitory and/or non-transitory memory of user device 710, which may store various applications and data and be utilized during execution of various modules of user device 710. Database 718 may store user profile relating to the user 740, predictions previously viewed or saved by the user 740, historical data received from the server 730, and/or the like. In some embodiments, database 718 may be local to user device 710. However, in other embodiments, database 718 may be external to user device 710 and accessible by user device 710, including cloud storage systems and/or databases that are accessible over network 760.

User device 710 includes at least one network interface component 717 adapted to communicate with data vendor server 745 and/or the server 730. In various embodiments, network interface component 717 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 745 may correspond to a server that hosts database 719 to provide training datasets including instruction data (e.g., 216) to the server 730. The database 719 may be implemented by one or more relational database, distributed databases, cloud databases, and/or the like.

The data vendor server 745 includes at least one network interface component 726 adapted to communicate with user device 710 and/or the server 730. In various embodiments, network interface component 726 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 745 may send asset information from the database 719, via the network interface 726, to the server 730.

The server 730 may be housed with the multi-modal training module 530 and its submodules described in FIG. 5A. In some implementations, multi-modal training module 530 may receive data from database 719 at the data vendor server 745 via the network 760 to generate an answer based on input images. The generated an answer based on input images may also be sent to the user device 710 for review by the user 740 via the network 760.

In one embodiment, an AI agent implementing the multi-modal training module 530 and its submodules described in FIG. 5A may be built based on an LLM as described in FIG. 5B. For example, the AI agent may be configured with one or more LLMs (e.g., each pretrained for a specific task or domain), a plurality of system prompts, and connected to external APIs to databases and applications (e.g., a search engine, a cloud service, an internal database, etc.).

In some embodiments, the AI agent implementing the multi-modal training module 530 and its submodules described in FIG. 5A may be implemented as a cloud-based AI agent which may be accessed by user device 710 via a chatbot application, a web application, customer support or SaaS applications. In another implementation, a client-side AI agent component may be delivered from the server 730 to user device 710 for local installation such that the client-side AI agent may be installed and runs directly on the user's device. Such local AI agent on the user device 710 may be available offline to adapt to privacy-sensitive applications. In another implementation, the AI agent implementing the multi-modal training module 530 and its submodules described in FIG. 5A may adopt a hybrid cloud and client-based structure to balance computing speed, cost and privacy. For example, a local AI agent may handle basic AI queries locally, but complex queries may be sent to server 730 to process.

The database 732 may be stored in a transitory and/or non-transitory memory of the server 730. In one implementation, the database 732 may store data obtained from the data vendor server 745. In one implementation, the database 732 may store parameters of the multi-modal training module 530. In one implementation, the database 732 may store previously generated answer based on input images, and the corresponding input feature vectors.

In some embodiments, database 732 may be local to the server 730. However, in other embodiments, database 732 may be external to the server 730 and accessible by the server 730, including cloud storage systems and/or databases that are accessible over network 760.

The server 730 includes at least one network interface component 733 adapted to communicate with user device 710 and/or data vendor servers 745, 770 or 780 over network 760. In various embodiments, network interface component 733 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 760 may be implemented as a single network or a combination of multiple networks. For example, in various embodiments, network 760 may include the Internet or one or more intranets, landline networks, wireless networks, and/or other appropriate types of networks. Thus, network 760 may correspond to small scale communication networks, such as a private or local area network, or a larger scale network, such as a wide area network or the Internet, accessible by the various components of system 700.

### Example Work Flows

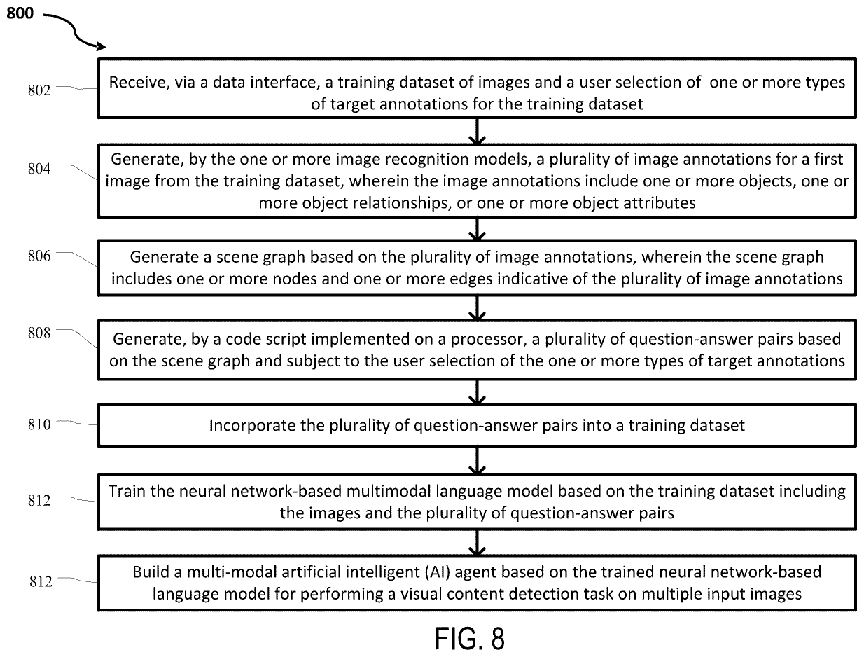

FIG. 8 is an example logic flow diagram illustrating a method of user-directed multimodal data generation for training a neural network-based multimodal language model based on the framework shown in FIGS. 1A-7, according to some embodiments described herein. One or more of the processes of method 800 may be implemented, at least in part, in the form of executable code stored on non-transitory, tangible, machine-readable media that when run by one or more processors may cause the one or more processors to perform one or more of the processes. In some embodiments, method 800 corresponds to the operation of the multi-modal training module 530 (e.g., FIGS. 5A and 7) that performs training of a multi-modal LLM.

In some embodiments, method 800 is performed by a system such as computing device 500, user device 710, server 730, or another device or combination of devices. Inputs (e.g., multiple images and a text query) may be received via a data interface such as data interface 515, network interface 717, network interface 733, or via a data interface that is integrated with a device. For example UI Application 712 may receive user inputs via a text input interface (e.g., keyboard), audio input (e.g., microphone), video interface (e.g., camera), or other interface for receiving user inputs (e.g., a mouse or touch display).

As illustrated, the method 800 includes a number of enumerated steps, but aspects of the method 800 may include additional steps before, after, and in between the enumerated steps. In some aspects, one or more of the enumerated steps may be omitted or performed in a different order.

At step 802, a training dataset of images and a user selection of one or more types of target annotations for the training dataset may be received via a communication interface. For example, the target annotations may be any of bounding boxes for objects, pixel-wise depth estimation, and/or a particular region or object of interest on an image. By enabling users to select specific annotations, the method 800 allows targeted control over which image features are emphasized during training, thereby improving the relevance and effectiveness of image model learning.

At step 804, one or more image recognition models (e.g., 402, 404, 406, 408 and 410 in FIG. 4) may generate a plurality of image annotations for a first image from the training dataset. The image annotations include one or more objects, one or more object relationships, or one or more object attributes. For example, the one or more image recognition models generate one or more bounding boxes associated with one or more detected objects on at least one image. For another example, the one or more image recognition models generate one or more depth parameters associated with one or more pixels on the at least one image. For another example, the one or more image recognition models generate one or more segmentations based on the one or more bounding boxes and the at least one image. For another example, the one or more image recognition models generate one or more attributes associated with each of the one or more detected objects based on the one or more bounding boxes and the at least one image. For example, the one or more image recognition models generate one or more relationships between the one or more segmentations based on the one or more segmentations and the at least one image.

At step 806, a scene graph (e.g., 210 in FIG. 4) may be generated based on the plurality of image annotations. The scene graph includes one or more nodes and one or more edges indicative of the plurality of image annotations. For example, the one or more nodes in the scene graph represent one or more of the segmentations associated with one or more attributes, and the one or more edges represent the one or more relationships.

At step 808, a code script (e.g., data generator 212 in FIG. 2) implemented on a processor may generate a plurality of question-answer pairs (e.g., 216 in FIG. 2) based on the scene graph and subject to the user selection of the one or more types of target annotations.

At step 810, the plurality of question-answer pairs may be incorporated into a training dataset. For example, the plurality of question-answer pairs include at least one question relating to selecting from, compare and/or aggregating more than one images and a ground-truth answer.

At step 812, the neural network-based multimodal language model may be trained based on the training dataset including the images and the plurality of question-answer pairs. For example, an image encoder of the neural network based multimodal language model encodes at least two images from the training dataset into image representations. A connector layer of the neural network based multimodal language model transforms image representations into embedding tokens for a language model. A language model decoder of the neural network based multimodal language model may generate predicted tokens from a combination of the embedding tokens and the text representation. The one or more of the text encoder, the image encoder, the connector layer and the language model decoder may then be updated based on a training loss comparing the predicted tokens and a ground-truth answer corresponding to the training question from the training dataset.

At step 814, a multi-modal AI agent may be based on the trained neural network-based language model for performing a visual content detection task on multiple input images.

In some embodiments, method 800 is applicable in a variety of applications. For example, the built multi-modal AI agent may receive the multiple input images taken at different time instances depicting a real-world object or scene, and generate an answer to a user question relating to the real-world object or scene by inputting the user question and the multiple input images to the trained neural network-based language model. For instance, the built multi-modal AI agent may generate diagnostic text by processing and comparing multiple input medical scans (e.g., CT, MRI, X-ray) and produces structured or free-text diagnostic summaries-such as identifying changes over time, comparing regions of interest, or supporting differential diagnosis-mirroring radiologist-style reporting. The multi-modal AI agent may then provide a user interface for displaying the generated diagnostic notes in various formats, e.g., as overlaying highlighted region of interests of a medical image, and/or the like.

In another example, the built multi-modal AI agent may process inputs such as camera images, LiDAR data, and map information to understand the driving environment. By integrating these modalities, the model identifies objects, lane boundaries, traffic signals, and dynamic agents (e.g., pedestrians, vehicles). It then generates an output, e.g., high-level driving commands—such as “slow down,” “turn left,” or “change lanes”—by reasoning over the scene and applying learned traffic rules, enabling context-aware decision-making for safe vehicle control.

### Example Results

Example data experiments are conducted to showcase the synthesized instruction data improves model performance, with data derived from manually annotated scene graphs generally outperforming those from model-generated scene graphs. Data format (short answer vs. multiple choice) and data scale significantly impact performance. Incorporating the data in both pre-training and fine-tuning stages yields the best results.

In one embodiment, instruction data is constructed, following diagram 200 in FIG. 2, from Visual Genome (described in Krishna et al., Visual genome: Connecting language and vision using crowdsourced dense image annotations. International journal of computer vision, 123:32-73, 2017), a large-scale manually annotated scene graph dataset. Each scene graph is augmented with depth and segmentation annotations using Depth Anything V2 and SAM-2. The resulting dataset includes 1.5 million single-image instructions (VG-S) and 4.2 million multi-image instructions (VG-M). VG-S is generated by sampling one instruction per image per generator, while VG-M consists of 100,000 samples per generator.

In another embodiment, a total of 120,000 high-resolution images containing more than five objects are sampled from the DataComp dataset (described in Gadre et al., Datacomp: In search of the next generation of multimodal datasets. Advances in Neural Information Processing Systems, 36, 2024). The scene graph generation pipeline described in FIG. 4 is applied to produce augmented scene graphs for these images. Using the same instruction generation process as above, 2.3 million single-image instructions (DCS) and 4.2 million multi-image instructions (DC-M) are created. Combined with the VG-S and VG-M sets, these four splits constitute over 10 million unique instruction samples, forming PROVISION-10M. Each instruction includes both multiple-choice and short-answer formats to support diverse training scenarios.

In one embodiment, the utility of the generated dataset is evaluated under two settings: augmentation and replacement. In the augmentation setting, the generated data is added to an existing base dataset used to train MLMs. In the replacement setting, a random subset of the base dataset is substituted with the generated data. Various augmentation and replacement ratios are tested. For instance, with a base dataset of 100K samples, a 5% augmentation ratio corresponds to adding 5K generated samples, while a 5% replacement ratio involves replacing 5K base samples. Instruction data is also evaluated across three answer format configurations: (1) all data in multiple-choice format, (2) all data in short-answer format, and (3) a balanced configuration with 50% in each format. These configurations are used to assess the influence of answer format on model performance and the adaptability of the dataset to different response styles.

In one embodiment, LLaVA-1.5 instruction data and its training protocol are used as the base for instruction tuning the LLaVA-1.5-7B model with single-image data. For multi-image instruction tuning, the LoRA training approach is applied to Mantis-SigLIP-8B, using Mantis-Instruct (excluding video-related subsets) as the base dataset. Additionally, the generated data is incorporated into both the pre-training and fine-tuning stages of the xGen-MM-4B model. Model performance is evaluated on a range of standard MLM benchmarks. Single-image benchmarks include CV-Bench (CVB) (described in Tong et al., Cambrian-1: A fully open, vision-centric exploration of multimodal LLMs, 2024), SEEDBench (Li et al., Seed-bench-2: Benchmarking multimodal large language models. arXiv preprint arXiv: 2311.17092, 2023; Li et al., Seed-bench: Benchmarking multimodal Ilms with generative comprehension. arXiv preprint arXiv: 2307.16125, 2023), MMBench (MMB) (Liu et al., Mmbench: Is your multimodal model an all-around player? arXiv preprint arXiv: 2307.06281, 2023), MME (Fu et al., Mme: A comprehensive evaluation benchmark for multimodal large language models, 2024), QBench2 (Wu et al., Q-bench: A benchmark for general-purpose foundation models on low-level vision, In ICLR, 2024), MMMU (Yue et al., Mmmu: A massive multi-discipline multimodal understanding and reasoning benchmark for expert agi. In Proceedings of CVPR, 2024), RealWorldQA (Grok-1.5 vision preview. https://x.ai/blog/grok-1.5v, 2024), MMStar (Chen et al., Are we on the right way for evaluating large vision-language models? CoRR, abs/2403.20330, 2024), and MMVet (Yu et al., Mm-vet: Evaluating large multimodal models for integrated capabilities. In Forty-first International Conference on Machine Learning, 2023), Multi-image benchmarks include Mantis-Eval and MMT-Bench (MMT) (Ying et al., Mmt-bench: A comprehensive multimodal benchmark for evaluating large vision-language models towards multitask agi, 2024).

Table 1 shows that for single-image instructions, models are evaluated using the base dataset and variations with four augmentation/replacement ratios and three instruction formats across eight benchmark datasets. In the replacement setting, instruction tuning the LLaVA-1.5-7B model with VG-S data consistently improves average performance over the base dataset, with peak performance observed at a 20% replacement ratio. Performance trends indicate that increasing the proportion of replaced multiple-choice data generally enhances results, while replacing short-answer data tends to degrade performance. In the augmentation setting, model performance improves with the addition of more VG-S samples across all data formats. Augmentation consistently outperforms replacement at equivalent data ratios. These findings suggest that, for single-image tasks, incorporating scene graph—generated instructions-particularly in a mix of short-answer and multiple-choice formats—can yield strong performance, especially when a significant fraction of the original data is replaced.

TABLE 1
Results of instruction tuning LLaVA-1.5-7B with VG-S

| | Data | Data Format | CVB- [symbol] | CVB- [symbol] | SEED | MMB | MME | QBench [symbol] | MMM [symbol] | RealWorld [symbol] | Avg. |
|---|---|---|---|---|---|---|---|---|---|---|---|
| LLaVA-1.5 instruction data | | | 58.0 | 61.0 | 66.8 | 66.7 | 63.2 | 46.4 | 36.2 | 54.2 | 56.6 |
| Replacemen [symbol] | 5% | Short | 55.0 | 66.0 | 67.1 | 66.3 | 64.2 | 48.5 | 36.7 | 52.7 | 57.1 |
| | | Multiple | 61.0 | 61.0 | 67.5 | 67.0 | 63.3 | 47.8 | 37.8 | 54.6 | 57.5 |
| | | Choice | | | | | | | | | |
| | | Half-Half | 60.0 | 66.0 | 67.4 | 66.5 | 62.5 | 46.6 | 37.4 | 55.6 | 57.8 |
| | 10% | Short | 58.0 | 67.0 | 67.0 | 67.4 | 64.2 | 49.2 | 37.8 | 56.1 | 58.3 |
| | | Multiple | 56.0 | 62.0 | 67.2 | 67.1 | 64.4 | 48.4 | 36.8 | 58.7 | 57.6 |
| | | Choice | | | | | | | | | |
| | | Half-Half | 56.0 | 64.0 | 67.0 | 67.3 | 63.4 | 46.5 | 36.7 | 56.0 | 57.1 |
| | 20% | Short | 59.0 | 66.0 | 67.3 | 66.8 | 63.4 | 47.7 | 36.1 | 54.5 | 57.6 |
| | | Multiple | 57.0 | 63.0 | 66.8 | 68.0 | 63.2 | 48.9 | 37.2 | 58.6 | 57.8 |
| | | Choice | | | | | | | | | |
| | | Half-Half | 63.0 | 66.0 | 67.5 | 66.7 | 62.5 | 46.7 | 39.1 | 57.9 | 58.7 |
| | 50% | Short | 54.0 | 69.0 | 65.9 | 64.9 | 60.5 | 50.2 | 35.2 | 55.7 | 56.9 |
| | | Multiple | 61.0 | 68.0 | 66.3 | 66.1 | 61.8 | 46.1 | 38.2 | 56.7 | 58.0 |
| | | [symbol] | | | | | | | | | |
| | | Half-Half | 65.0 | 69.0 | 66.6 | 65.0 | 62.3 | 47.2 | 38.1 | 55.3 | 58.6 |
| Augmentati [symbol] | 5% | Short | 55.0 | 65.0 | 66.7 | 66.5 | 63.9 | 48.1 | 37.3 | 55.6 | 57.2 |
| | | Multiple | 60.0 | 63.0 | 66.5 | 67.7 | 64.1 | 47.7 | 37.8 | 55.7 | 57.8 |
| | | Choice | | | | | | | | | |
| | | Half-Half | 56.0 | 66.0 | 66.8 | 67.1 | 61.6 | 46.5 | 37.6 | 56.1 | 57.2 |
| | 10% | Short | 59.0 | 69.0 | 66.7 | 66.9 | 62.3 | 49.0 | 37.3 | 54.0 | 58.0 |
| | | Multiple | 60.0 | 64.0 | 66.4 | 66.7 | 63.3 | 47.6 | 37.1 | 56.0 | 57.6 |
| | | Choice | | | | | | | | | |
| | | Half-Half | 57.0 | 67.0 | 68.0 | 68.1 | 64.2 | 45.3 | 38.4 | 55.0 | 57.9 |
| | 20% | Short | 59.0 | 68.0 | 67.2 | 68.0 | 61.6 | 48.5 | 37.6 | 54.0 | 58.0 |
| | | Multiple | 58.0 | 63.0 | 67.0 | 67.7 | 63.3 | 46.2 | 37.6 | 56.6 | 57.4 |
| | | Choice | | | | | | | | | |
| | | Half-Half | 58.0 | 67.0 | 67.7 | 67.2 | 63.0 | 46.7 | 36.4 | 57.9 | 58.0 |
| | 50% | Short | 57.0 | 69.0 | 67.2 | 68.0 | 64.5 | 49.4 | 37.2 | 55.3 | 58.5 |
| | | Multiple | 61.0 | 68.0 | 67.4 | 67.8 | 63.3 | 48.5 | 36.3 | 56.6 | 58.6 |
| | | Choice | | | | | | | | | |
| | | Half-Half | 60.0 | 66.0 | 67.5 | 67.6 | 66.0 | 48.7 | 38.9 | 57.6 | 59.0 |

[symbol]

indicates data missing or illegible when filed

Table 2 shows that for multi-image instructions, models are evaluated on two multi-image benchmarks and six single-image benchmarks across various replacement and augmentation settings. At a 20% replacement ratio, the half-half format achieves the highest average score of 59.7 across both benchmark types, indicating the effectiveness of combining multiple-choice and short-answer formats. However, at a 50% replacement ratio, overall performance declines, suggesting that excessive replacement with new data may hinder generalization. In the augmentation setting, the multiple-choice format yields an average score of 60.0 at a 20% ratio, while the half-half format achieves the highest overall score of 60.1 at 50% augmentation. These results highlight the benefits of augmentation, particularly when using mixed data formats. Augmentation also demonstrates greater stability in model performance across both multi-image and single-image benchmarks compared to replacement. Notably, strong results are observed in multi-image benchmarks (Mantis-Eval and MMT) with the half-half format at 10% augmentation and the multiple-choice format at 20% augmentation. These findings underscore the value of scene graph-generated instruction data in helping models learn to select, compare, and integrate features across multiple images.

TABLE 2
Table 2. Results of instruction tuning Mantis-SigLIP-8B with VG-M

| | Data | | Multi-image benchmark | | Single-image benchmark | | | | | | |
|---|---|---|---|---|---|---|---|---|---|---|---|
| | Ratio* | Data Format | Mantis-Eval | MMT | SEED | MMB | MME | QBench2 | MMMU | RealWorldQA | Avg. |
| Mantis instruction data | | | 54.4 | 52.9 | 68.1 | 72.8 | 58.5 | 70.1 | 44.3 | 51.5 | 59.1 |
| Replacement | 5% | Short Answer | 59.9 | 52.5 | 68.4 | 73.3 | 60.0 | 70.3 | 41.4 | 50.3 | 59.5 |
| | | Multiple Choice | 57.6 | 52.8 | 68.0 | 73.0 | 58.4 | 70.5 | 43.7 | 52.3 | 59.5 |
| | | Half-Half | 57.6 | 53.4 | 68.1 | 71.7 | 57.8 | 71.5 | 44.4 | 50.9 | 59.4 |
| | 10% | Short Answer | 69.0 | 54.8 | 68.6 | 73.7 | 57.4 | 68.4 | 41.3 | 50.7 | 59.2 |
| | | Multiple Choice | 59.9 | 53.1 | 68.3 | 71.7 | 57.5 | 68.6 | 45.3 | 51.9 | 59.5 |
| | | Half-Half | 59.0 | 53.7 | 68.2 | 72.6 | 58.6 | 68.9 | 43.1 | 51.5 | 59.4 |
| | 20% | Short Answer | 62.7 | 52.9 | 68.2 | 72.9 | 56.6 | 70.2 | 45.4 | 49.7 | 59.8 |
| | | Multiple Choice | 57.6 | 52.2 | 68.0 | 72.9 | 57.7 | 67.4 | 42.0 | 51.4 | 58.6 |
| | | Half-Half | 58.5 | 58.6 | 68.7 | 72.2 | 59.6 | 69.4 | 44.1 | 51.8 | 59.7 |
| | 50% | Short Answer | 57.1 | 53.2 | 67.4 | 70.4 | 58.6 | 65.2 | 42.2 | 51.2 | 58.2 |
| | | Multiple Choice | 55.8 | 52.5 | 67.5 | 69.8 | 57.5 | 67.9 | 42.6 | 53.5 | 58.4 |
| | | Half-Half | 54.8 | 54.0 | 67.9 | 72.1 | 58.2 | 66.8 | 43.7 | 51.5 | 58.6 |
| Augmentation | 5% | Short Answer | 60.4 | 53.8 | 68.3 | 71.2 | 58.9 | 70.6 | 44.3 | 48.9 | 59.5 |
| | | Multiple Choice | 58.1 | 54.0 | 68.1 | 71.7 | 58.8 | 70.3 | 42.4 | 50.2 | 59.2 |
| | | Half-Half | 58.1 | 52.5 | 68.0 | 71.8 | 58.4 | 70.1 | 41.3 | 52.9 | 59.1 |
| | 10% | Short Answer | 60.4 | 53.0 | 68.1 | 72.8 | 59.2 | 71.4 | 44.2 | 50.6 | 60.0 |
| | | Multiple Choice | 60.4 | 52.7 | 68.0 | 72.2 | 59.2 | 71.1 | 43.1 | 50.2 | 59.6 |
| | | Half-Half | 61.3 | 53.0 | 68.0 | 72.9 | 60.0 | 67.7 | 42.0 | 51.0 | 59.5 |
| | 20% | Short Answer | 57.1 | 53.2 | 68.5 | 72.3 | 60.3 | 71.6 | 43.8 | 50.3 | 59.6 |
| | | Multiple Choice | 58.5 | 52.9 | 68.6 | 72.1 | 60.6 | 71.6 | 43.0 | 51.5 | 60.0 |
| | | Half-Half | 60.4 | 52.8 | 68.5 | 72.4 | 60.6 | 68.4 | 43.7 | 52.7 | 59.9 |
| | 50% | Short Answer | 57.6 | 53.0 | 68.1 | 71.6 | 59.1 | 70.4 | 44.3 | 51.2 | 59.4 |
| | | Multiple Choice | 58.5 | 54.1 | 68.4 | 72.4 | 58.8 | 70.1 | 41.4 | 51.6 | 59.4 |
| | | Half-Half | 60.4 | 53.7 | 68.1 | 73.4 | 60.4 | 69.7 | 43.8 | 51.6 | 60.1 |

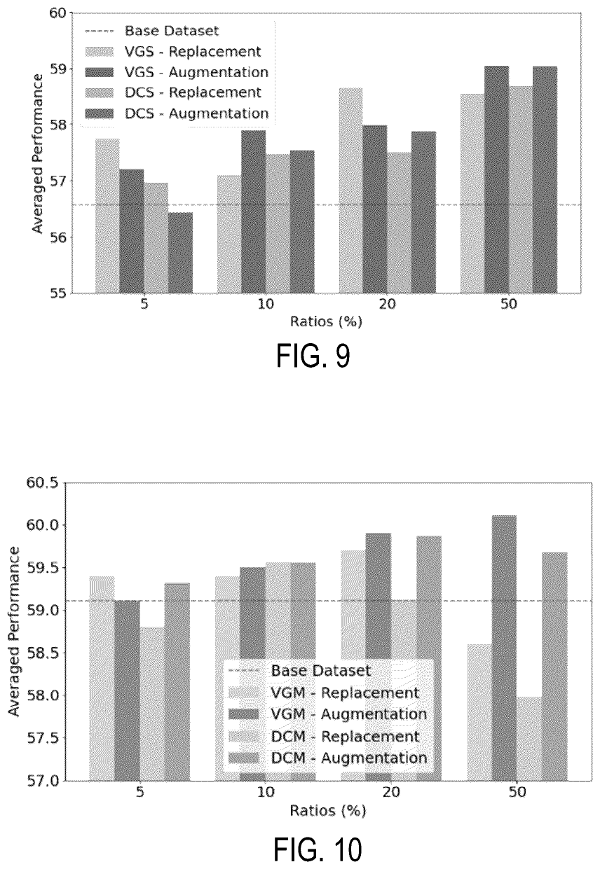

Models trained on instruction data derived from manually annotated (VG-S, VG-M) and model-generated (DC-S, DC-M) scene graphs are compared to assess the impact of data source quality. As shown in FIG. 9 (VG-S vs. DC-S), DC-S underperforms VG-S at lower data ratios. However, at a 50% replacement ratio, DC-S achieves performance comparable to VG-S, indicating that increased data volume can help close the gap between model-generated and human-curated inputs.

In the multi-image setting (FIG. 10, VG-M vs. DC-M), model performance under replacement settings initially improves with increased data ratio but subsequently declines, suggesting diminishing returns at higher ratios. Specifically, DC-M consistently lags behind VG-M, with performance instability observed at larger replacement or augmentation scales—highlighting potential edge effects when relying heavily on model-generated scene graphs in multi-image contexts. Overall, instruction data from manually annotated scene graphs tends to yield better performance than that from model-generated scene graphs. Nevertheless, both data types contribute positively to model training under most configurations.

To evaluate the impact of incorporating the generated data at scale during pre-training, and to compare its effects in pre-training versus fine-tuning stages, the xGen-MM (BLIP-3) training framework is used as the foundation. A baseline is established by pre-training a model on approximately 10 billion tokens using the xGen-MM pre-training recipe without any generated data. For fine-tuning, a separate baseline is constructed using 1 million samples, also excluding the generated data.

In the augmentation setup, additional data is incorporated into both the pre-training and fine-tuning stages, with generated data comprising approximately 5% of the total dataset at each stage. To evaluate the impact of scene graph source quality on single-image instruction data generation, two experimental conditions are tested: one using human-annotated scene graphs (VG-S) and another using synthesized scene graphs from the generation pipeline (DC-S). Results summarized in Table 3 yield the following observations:

Performance Gains from Augmentation: Augmenting the base training recipes with either VG-S or DC-S data improves performance across all 11 benchmarks, demonstrating the effectiveness of integrating vision-centric knowledge into multimodal model training.

Synergistic Benefit of Dual-Stage Augmentation: Applying augmentation at both the pre-training and fine-tuning stages produces higher performance than augmenting at a single stage. Dual-stage augmentation yields the highest average scores, with VG-S achieving +1.6% and DC-S achieving+1.2% gains, indicating a cumulative benefit from combining both stages.

Comparison Between VG-S and DC-S: While both data sources contribute to performance improvements, VG-S achieves slightly higher average scores (60.1%) compared to DC-S (59.7%) under dual-stage augmentation, suggesting that higher-quality, human-annotated scene graphs may further enhance instruction generation effectiveness.

TABLE 3
Comparison of augmenting the base data recipe

| Augment in | Augment in | CVB- | CVB- | | | | | | | | | | |
|---|---|---|---|---|---|---|---|---|---|---|---|---|---|
| Pre-train | Fine-tune | 2D | 3D | SEED | MMB | MMStar | MME | QBench2 | MMVet | MMMU | RealWorldQA | TextVQA | Avg. |
| X | X | 62.9 | 73.5 | 70.1 | 73.9 | 44.1 | 62.1 | 53.9 | 38.2 | 41.6 | 56.2 | 66.5 | 58.5 |

DC-S: DataComp images and model-generated synthetic scene graphs

| | | | | | | | | | | | | | |
|---|---|---|---|---|---|---|---|---|---|---|---|---|---|
| X | ✓ | 64.5 | 71.9 | 69.1 | 73.3 | 44.8 | 60.9 | 57.9 | 35.2 | 44.1 | 59.7 | 67.0 | 58.9 |
| ✓ | X | 67.9 | 70.8 | 70.4 | 73.5 | 45.5 | 64.4 | 53.6 | 37.7 | 46.1 | 58.8 | 67.1 | 59.6 |
| ✓ | ✓ | 68.3 | 75.5 | 69.6 | 74.5 | 44.4 | 62.4 | 54.0 | 38.5 | 41.9 | 61.6 | 66.5 | 59.7 |

VG-S: Visual Genome images and scene graphs

| | | | | | | | | | | | | | |
|---|---|---|---|---|---|---|---|---|---|---|---|---|---|
| X | ✓ | 67.7 | 72.2 | 70.0 | 73.6 | 45.5 | 64.2 | 54.4 | 36.7 | 42.9 | 60.4 | 67.3 | 59.5 |
| ✓ | X | 65.9 | 73.3 | 70.5 | 75.9 | 44.8 | 64.9 | 56.3 | 36.8 | 42.2 | 59.2 | 67.3 | 59.7 |
| ✓ | ✓ | 70.2 | 73.7 | 69.9 | 73.9 | 44.3 | 64.0 | 55.7 | 40.4 | 44.8 | 57.4 | 66.8 | 60.1 |

A key strength of the proposed pipeline lies in its scalability, allowing integration into large-scale multimodal language model training. To evaluate the effect of scale, two pre-training configurations are tested: one with 0.75 million VG-S samples and another with 1.5 million samples, while keeping the fine-tuning setup unchanged. As reported in Table 4, increasing the amount of VG-S data during pre-training leads to a consistent improvement in average performance across 12 benchmarks, rising from 61.4% to 62.3%. These results highlight the potential of the generated data to enhance model performance at scale in multimodal foundation model training.

TABLE 4
Impact of dataset augmentation scale on model performance

| Dataset Augmentation | Avg. |
|---|---|
| No Augmentation | 58.5 |
| 0.75 Million | 59.1 |
| 1.5 Million | 60.1 |

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of user-directed multimodal data generation for training a neural network-based multimodal language model, the method comprising:
receiving, via a data interface, a training dataset of images;
receiving, via a user interface, a user selection of one or more types of target annotations for the training dataset;
generating, by the one or more image recognition models, a plurality of image annotations for a first image from the training dataset, wherein the image annotations include one or more objects, one or more object relationships, or one or more object attributes;
generating a scene graph based on the plurality of image annotations, wherein the scene graph includes one or more nodes and one or more edges indicative of the plurality of image annotations;
generating, by a code script implemented on a processor, a plurality of question-answer pairs based on the scene graph and subject to the user selection of the one or more types of target annotations;
incorporating the plurality of question-answer pairs into a training dataset;
training the neural network-based multimodal language model based on the training dataset including the images and the plurality of question-answer pairs; and
building a multi-modal artificial intelligent (AI) agent based on the trained neural network-based language model for performing a visual content detection task on multiple input images.

2. The method of claim 1, wherein the one or more image recognition models generate one or more bounding boxes associated with one or more detected objects on at least one image.

3. The method of claim 2, wherein the one or more image recognition models generate one or more depth parameters associated with one or more pixels on the at least one image.

4. The method of claim 2, wherein the one or more image recognition models generate one or more segmentations based on the one or more bounding boxes and the at least one image.

5. The method of claim 2, wherein the one or more image recognition models generate one or more attributes associated with each of the one or more detected objects based on the one or more bounding boxes and the at least one image.

6. The method of claim 4, wherein the one or more image recognition models generate one or more relationships between the one or more segmentations based on the one or more segmentations and the at least one image.

7. The method of claim 6, wherein the one or more nodes in the scene graph represent one or more of the segmentations associated with one or more attributes, and the one or more edges represent the one or more relationships.

8. The method of claim 1, wherein the plurality of question-answer pairs include at least one question relating to selecting from, compare and/or aggregating more than one images and a ground-truth answer.

9. The method of claim 1, wherein the training the neural network based multimodal language model further comprises training the neural network based multimodal language model to generate an answer to a training question relating to at least two images, including:
encoding, by a text encoder of the neural network based multimodal language model, the training question into a text representation;
encoding, by an image encoder of the neural network based multimodal language model, the at least two images from the training dataset into image representations;
transforming, by a connector layer of the neural network based multimodal language model, image representations into embedding tokens for a language model;
generating, by a language model decoder of the neural network based multimodal language model, predicted tokens from a combination of the embedding tokens and the text representation;
updating one or more of the text encoder, the image encoder, the connector layer and the language model decoder based on a training loss comparing the predicted tokens and a ground-truth answer corresponding to the training question from the training dataset.

10. The method of claim 1, further comprising:
receiving the multiple input images taken at different time instances depicting a real-world object or scene; and
generating, by the multi-modal AI agent, an answer to a user question relating to the real-world object or scene by inputting the user question and the multiple input images to the trained neural network-based language model.

11. A system of user-directed multimodal data generation for training a neural network-based multimodal language model, the system comprising:
a memory that stores the neural network-based multimodal language model and a plurality of processor executable instructions;
a communication interface that receives, a training dataset of images and a user selection of one or more types of target annotations for the training dataset; and
one or more hardware processors that read and execute the plurality of processor-executable instructions from the memory, wherein the plurality of processor-executable instructions are configurable to cause the system to perform operations comprising:
generating, by the one or more image recognition models, a plurality of image annotations for a first image from the training dataset, wherein the image annotations include one or more objects, one or more object relationships, or one or more object attributes;
generating a scene graph based on the plurality of image annotations, wherein the scene graph includes one or more nodes and one or more edges indicative of the plurality of image annotations;
generating, by a code script, a plurality of question-answer pairs based on the scene graph and subject to the user selection of the one or more types of target annotations;
incorporating the plurality of question-answer pairs into a training dataset;
training the neural network-based multimodal language model based on the training dataset including the images and the plurality of question-answer pairs; and
building a multi-modal artificial intelligent (AI) agent based on the trained neural network-based language model for performing a visual content detection task on multiple input images.

12. The system of claim 11, wherein the one or more image recognition models generate one or more bounding boxes associated with one or more detected objects on at least one image.

13. The system of claim 12, wherein the one or more image recognition models generate one or more depth parameters associated with one or more pixels on the at least one image.

14. The system of claim 12, wherein the one or more image recognition models generate one or more segmentations based on the one or more bounding boxes and the at least one image.

15. The system of claim 12, wherein the one or more image recognition models generate one or more attributes associated with each of the one or more detected objects based on the one or more bounding boxes and the at least one image.

16. The system of claim 14, wherein the one or more image recognition models generate one or more relationships between the one or more segmentations based on the one or more segmentations and the at least one image.

17. The system of claim 16, wherein the one or more nodes in the scene graph represent one or more of the segmentations associated with one or more attributes, and the one or more edges represent the one or more relationships.

18. The system of claim 11, wherein the operation of training the neural network based multimodal language model further comprises training the neural network based multimodal language model to generate an answer to a training question relating to at least two images, including:
encoding, by a text encoder of the neural network based multimodal language model, the training question into a text representation;
encoding, by an image encoder of the neural network based multimodal language model, the at least two images from the training dataset into image representations;
transforming, by a connector layer of the neural network based multimodal language model, image representations into embedding tokens for a language model;
generating, by a language model decoder of the neural network based multimodal language model, predicted tokens from a combination of the embedding tokens and the text representation;
updating one or more of the text encoder, the image encoder, the connector layer and the language model decoder based on a training loss comparing the predicted tokens and a ground-truth answer corresponding to the training question from the training dataset.

19. The system of claim 11, wherein the operations further comprise:
receiving the multiple input images taken at different time instances depicting a real-world object or scene; and
generating, by the multi-modal AI agent, an answer to a user question relating to the real-world object or scene by inputting the user question and the multiple input images to the trained neural network-based language model.

20. A non-transitory machine-readable medium comprising a plurality of instructions for user-directed multimodal data generation for training a neural network-based multimodal language model, executable by one or more processors, wherein the plurality of instructions are configurable to cause the one or more processors to perform operations comprising:
receiving, via a data interface, a training dataset of images;
receiving, via a user interface, a user selection of one or more types of target annotations for the training dataset;
generating, by the one or more image recognition models, a plurality of image annotations for a first image from the training dataset, wherein the image annotations include one or more objects, one or more object relationships, or one or more object attributes;
generating a scene graph based on the plurality of image annotations, wherein the scene graph includes one or more nodes and one or more edges indicative of the plurality of image annotations;
generating, by a code script implemented on a processor, a plurality of question-answer pairs based on the scene graph and subject to the user selection of the one or more types of target annotations;
incorporating the plurality of question-answer pairs into a training dataset;
training the neural network-based multimodal language model based on the training dataset including the images and the plurality of question-answer pairs; and
building a multi-modal artificial intelligent (AI) agent based on the trained neural network-based language model for performing a visual content detection task on multiple input images.
